(19) United States
(12) Patent Application Publication
(10) Pub. No.: US 2018/0003662 A1
(43) Pub. Date: Jan. 4, 2018

(54) METHOD AND APPARATUS FOR MONITORING A BEARING STATE OF A PROBE

(71) Applicant: CARL ZEISS INDUSTRIELLE MESSTECHNIK GMBH, OBERKOCHEN (DE)

(72) Inventors: Anton FUCHS, BOEHMENKIRCH (DE); Rudolf KERN, AALEN (DE)

(21) Appl. No.: 15/633,018

(22) Filed: Jun. 26, 2017

(30) Foreign Application Priority Data
Jun. 30, 2016 (DE) 10 2016 211 936.2

(51) Int. Cl. G01N 27/20; G01M 13/04; G01B 5/008

(52) U.S. Cl. CPC G01N 27/20; G01M 13/04; G01B 5/008

(57) ABSTRACT

A method and an apparatus for monitoring a bearing state of a probe or probe part of a coordinate measuring machine, wherein the apparatus comprises at least one evaluation device and at least one monitoring circuit. A probe-side bearing section is mountable on a measuring-machine-side bearing section via a plurality of bearing devices. The monitoring circuit comprises at least one subcircuit per bearing device. A variable dependent on a resistance of the monitoring circuit is determinable. A resistance value of the subcircuit in a closed state of the bearing device is different than a resistance value of the subcircuit in the open state of the bearing device. The monitoring circuit is designed in such a way that an open or closed bearing state of each bearing device is determinable depending on the variable dependent on the resistance of the monitoring circuit.

### CROSS-REFERENCE TO RELATED APPLICATION

This application claims priority from German patent application DE 10 2016 211 936.2, filed on Jun. 30, 2016. The entire content of this prior application is incorporated herein by reference.

### BACKGROUND OF THE INVENTION

The invention relates to an apparatus and a method for monitoring a bearing state of a probe or probe part of a coordinate measuring machine.

It is known to use coordinate measuring machines for measuring measurement objects. For this purpose, a probe, for example a probe of a contacting or non-contact measuring system, is mounted on a movable part of the coordinate measuring machine via bearing devices and is then secured by means of suitable securing devices. In this case, the corresponding bearing devices serve for reproducible securing in a predetermined position and with a predetermined orientation.

It is known to use so-called three-point bearings. Various embodiments are known for this purpose. In this regard, e.g. bearing devices can comprise a ball/ball pair, ball/roller pair, roller/ball pair and roller/roller pair. In this case, elements of the pairs explained above denote a measuring-machine-side part of the bearing device and the further part of the pair denotes a probe-side part.

It is furthermore known to carry out a bearing location monitoring by determining a resistance or a variable dependent on a resistance of a monitoring circuit. In this case, a resistance of a monitoring circuit changes depending on an open or closed bearing device.

In this regard, FIG. 1 shows a monitoring circuit 1 with three bearing devices L1, L2, L3, each comprising a measuring-machine-side part L1a, L2a, L3a and a probe-side part L1b, L2b, L3b. In this case, said parts L1a, . . . , L3b are indicated as circles and, depending on the embodiment, can be designed e.g. as ball or roller.

In a closed state of the respective bearing device L1, L2, L3, the probe is secured in a desired position and with a desired orientation on a coordinate measuring machine. A closed bearing device L1, L2, L3 forms an electrically conductive connection, while an open bearing device L1, L2, L3 forms an interrupted and thus non-conductive electrical connection. A closed state may be manifested particularly when the probe is mounted properly on the coordinate measuring machine. An open state may be manifested particularly when the probe is not mounted properly or is not mounted on the coordinate measuring machine.

Furthermore, the monitoring circuit comprises resistors R0, R1, R2, R3. A first resistor R1 is electrically arranged in series with the electrical connection that can be provided by the first bearing device L1, in particular in series with the measuring-machine-side part Da of the first bearing device L1. A second resistor R2 is electrically arranged in series with the electrical connection that can be provided by the second bearing device L2, in particular in series with the measuring-machine-side part L2a of the second bearing device L2. A third resistor R3 is electrically arranged in series with the electrical connection that can be provided by the third bearing device L3, in particular in series with the measuring-machine-side part L3a of the third bearing device L3.

A so-called pull-up resistor RP is furthermore illustrated. A voltage terminal V+ for a supply voltage and a reference potential V0 are furthermore illustrated. A first terminal point A of the monitoring circuit 1 and a second terminal point B of the monitoring circuit 1 are furthermore illustrated. In this case, a monitoring voltage Vm is the voltage dropped between the first and second terminal points A, B. Said voltage is detectable or determinable by means of a suitable device. The pull-up resistor RP is arranged between the first terminal point A and the voltage terminal V+.

A reference resistor R0 and the above-explained series circuits comprising the electrical connections that can be provided by the bearing devices L1, L2, L3 are connected in parallel between the first and second terminal points A, B.

Depending on the bearing state (open, closed) of the individual bearing devices L1, L2, L3, different voltage levels are measured for the monitoring voltage Vm. By way of example, if the resistance value of the pull-up resistor RP is 10 kΩ, the resistance value of the reference resistor R0 is 100 kΩ and a resistance value of each resistor R1, R2, R3 is 51.1 kΩ, then in the case where all the bearing devices L1, L2, L3 are open, the reference voltage is detected. If all three bearing devices L1, L2, L3 are closed, then the monitoring voltage Vm is 0.59 times the supply voltage. If only two bearing devices are closed, then the monitoring voltage Vm is 0.67 times the supply voltage. If only one bearing device L1, L2, L3 is closed, then the monitoring voltage Vm is 0.77 times the supply voltage.

FIG. 2 illustrates a further known monitoring circuit 1. The latter comprises the series circuit formed by all the electrical connections that are provided by the three bearing devices L1, L2, L3 in each case in the closed state. A pull-up resistor RP is furthermore illustrated. Only in the case where all three bearing devices L1, L2, L3 are closed, a monitoring voltage Vm with a magnitude of 0 V is detected. In all other cases, the supply voltage is detected as monitoring voltage Vm.

What is problematic is that the monitoring circuits 1 illustrated do not afford any possibility of identifying which bearing device L1, L2, L3 has opened. The monitoring circuit 1 in accordance with the embodiment in FIG. 2 furthermore disadvantageously makes it possible that in the case of at least one open bearing device L1, L2, L3 there is no identification of how many bearing devices L1, L2, L3 have opened.

DE 44 41 828 A1 is furthermore known. The latter relates to a method and an arrangement for sliding bearing diagnosis by means of magnetic field measurement.

DE 42 22 990 A1 is furthermore known. The latter relates to contact identification for diverse physical application.

The technical problem is therefore addressed of providing a method and an apparatus for monitoring a bearing state of a probe or probe part on a coordinate measuring machine which enables an improved monitoring of all bearing devices, in particular the identification of open bearing devices.

### SUMMARY OF THE INVENTION

The solution to the technical problem is evident from the subjects having the features of claims 1 and 11. Further advantageous configurations of the invention are evident from the dependent claims.

It is a basic concept of the invention to provide an apparatus for monitoring a bearing state with a monitoring circuit, wherein a resistance value of the monitoring circuit makes it possible to determine the number of open bearing devices and also to determine which bearing device is open.

An apparatus for monitoring a bearing state of a probe or probe part of a coordinate measuring machine is proposed.

In this case, the probe can comprise a sensor carrier and at least one sensor, wherein the sensor carrier can be mounted on the coordinate measuring machine, in particular on a movable part of the coordinate measuring machine, and the sensor can be mounted on the sensor carrier. The sensor carrier can be designed in particular as a rotary-pivoting joint. The movable part of the coordinate measuring machine can be or comprise in particular a measuring arm, for example a ram, of the coordinate measuring machine.

Moreover, the probe can comprise a sensor, wherein the sensor can be mounted on the coordinate measuring machine, in particular on the movable part of the coordinate measuring machine. In this case, it is possible for the probe not to comprise a sensor carrier.

A sensor in turn can comprise a plurality of sensor parts which can be mounted on one another. A sensor part can be a probe part. By way of example, a sensor can comprise a signal generating part and a stylus part, wherein the stylus part can be mounted on the signal generating part.

In this case, a sensor can comprise a device for generating a corresponding sensing signal. The sensor can be e.g. a tactile or optical sensor. It goes without saying that further sensors can also be used.

In this case, a probe-side bearing section is mounted on a measuring-machine-side bearing section. A probe-side bearing section can also be a probe-part-side bearing section. As a result, the probe for measuring a measurement object can e.g. be mounted on a movable part of the coordinate measuring machine and be secured in the mounted state.

The probe-side bearing section and the measuring-machine-side bearing section can form a mechanical interface device. In this case, the measuring-machine-side bearing section denotes a section of the interface device that is arranged on the measuring machine side. The probe-side bearing section denotes a section of the interface device that is arranged on the probe side.

By way of example, the coordinate measuring machine, in particular a movable part of the coordinate measuring machine, can have or form the measuring-machine-side bearing section. Moreover, a part that is connected or connectable to the coordinate measuring machine or to the movable part can have or form the measuring-machine-side bearing section. By way of example, the part having the measuring-machine-side bearing section can be connectable to the movable part via at least one further interface device. Consequently, a part of the probe that is connected or connectable to the movable part of the coordinate measuring machine, e.g. via a further interface device, can also have the measuring-machine-side bearing section.

In particular, a so-called plate carrier can have the measuring-machine-side bearing section. Consequently, it is thus possible for the coordinate measuring machine, a movable part of the coordinate measuring machine, a sensor carrier, a sensor or a part of a sensor to have or form the measuring-machine-side bearing section.

Furthermore, the probe or a part of the probe can have or form the probe-side bearing section. In particular, a so-called (sensor) plate can have the probe-side bearing section. Consequently, it is thus possible for a sensor carrier, a sensor or a part of a sensor to have or form the corresponding probe-side bearing section.

By way of example, a movable part of the coordinate measuring machine can have the measuring-machine-side bearing section, wherein a sensor carrier or sensor to be mounted on the movable part has the probe-side bearing section. Moreover, a sensor carrier can have the measuring-machine-side bearing section, wherein a sensor to be mounted on the sensor carrier has the probe-side bearing section. Moreover, a part of the sensor, for example a signal generating part, can have the measuring-machine-side bearing section, wherein a further part of the sensor, for example a stylus part, that is to be mounted on said part has the probe-side bearing section.

In other words, the measuring-machine-side bearing section has a receiving device for receiving the probe-side section. In this case, probe-side bearing sections of different probes or stylus, e.g. with different stylus combinations and/or geometries, can be mounted and secured on the measuring-machine-side bearing section.

Furthermore, the probe-side bearing section is mountable on the measuring-machine-side bearing section via a plurality of bearing devices. A plurality of bearing devices, that is to say at least two thereof, serve for mounting. A bearing device can comprise in particular a probe-side part and a measuring-machine-side part. In this case, a measuring-machine-side part of the bearing device denotes a part of the bearing device that is arranged on the measuring machine side or is arrangeable on the measuring machine side. In this case, a probe-side part of the bearing device denotes a part of the bearing device that is arranged on the probe side or is arrangeable on the probe side. The probe-side part of the bearing device denotes that part of the bearing device which is mountable on the measuring-machine-side part.

The measuring-machine-side bearing section can comprise the measuring-machine-side parts of the bearing devices. Furthermore, the probe-side bearing section can comprise the probe-side parts of the bearing devices.

For mounting purposes, the probe-side part is mounted e.g. in, at or on the measuring-machine-side part of the bearing device, or vice versa. It is conceivable for the probe-side part to comprise at least one ball or at least one roller. The measuring-machine-side part can likewise comprise at least one, preferably a plurality of, ball(s) or roller(s).

In this case, the parts mounted on one another can be secured on one another in the mounted state. In this regard, e.g. the sensor carrier or the sensor can be mounted on the movable part of the coordinate measuring machine and can be secured on said movable part in the mounted state. Moreover, a sensor part can be mounted on a further sensor part and can be secured on the latter in the mounted state.

In this case, the bearing devices are arranged and/or designed in such a way that a desired position and orientation of the part to be mounted can be set in a reproducible manner. By way of example, the bearing devices are arranged and/or designed in such a way that the probe or a part thereof can be mounted in a reproducible position and orientation on the coordinate measuring machine, in particular a movable part of the coordinate measuring machine.

The parts mounted on one another can be secured on one another mechanically and/or magnetically and/or with a further type of securing. For this purpose, it is possible in particular to generate a securing force.

By way of example, the parts to be secured on one another, for example the probe and/or the movable part of the coordinate measuring machine, or bearing sections can have a corresponding connection means, e.g. locking or latching means. Moreover, the parts to be secured on one another, or bearing sections, can have at least one magnet that is activatable and deactivatable. If the magnet is activated, then a securing force is generated which secures the parts on one another. In this case, a measuring-machine-side bearing section or a probe-side bearing section can comprise the at least one magnet.

The proposed apparatus comprises at least one evaluation device. The latter can for example be designed as or comprise a microcontroller. Furthermore, the apparatus comprises at least one monitoring circuit. In this case, the elements of the monitoring circuit can be a part of the proposed apparatus.

Furthermore, a variable dependent on a resistance of the monitoring circuit is determinable. Said variable can also be designated as resistance-dependent variable. The resistance-dependent variable can also be the resistance of the monitoring circuit. As explained in even greater detail below, the resistance-dependent variable can be in particular a monitoring voltage that is dropped across the monitoring circuit.

By way of example, the monitoring circuit can have two terminal points, wherein the resistance denotes a resistance of the electrical circuit arranged between the terminal points. One of the terminal points can be connected to a reference potential. The reference potential can be a ground potential, in particular. In this case, the resistance of the monitoring circuit can be determined in particular as resistance between an input terminal of the monitoring circuit and said reference potential.

According to the invention, the monitoring circuit comprises at least one subcircuit per bearing device, wherein a resistance value of the subcircuit in a closed state of the bearing device is different than a resistance value of the subcircuit in the open state of the bearing device.

In this case, a subcircuit can comprise in particular the measuring-machine-side part of a bearing device. Consequently, a subcircuit can comprise a section which forms a closed electrical connection in the closed state of the bearing device and an open electrical connection in the open state of the bearing device. The closed electrical connection can be produced in particular via the at least one measuring-machine-side part and the at least one probe-side part in the mounted state. In this case, the mechanical connection via the bearing device can also produce an electrical connection.

In a closed state of a bearing device, the measuring-machine-side part and the probe-side part can thus form a conductive connection, that is to say a closed current path, wherein said conductive connection can be part of the subcircuit.

Furthermore, the monitoring circuit is designed in such a way that an open or closed bearing state of each bearing device is determinable depending on the variable dependent on the resistance of the monitoring circuit.

Consequently, firstly the number of open and closed bearing devices is determinable. Furthermore, the fact of which of the bearing devices is open and which is closed is determinable. This last can also be referred to as identification of open bearing devices.

Resistance values of the subcircuits can be chosen in this case e.g. in such a way, and/or the subcircuits can be electrically connected in that case in such a way, that mutually different resistance values of the monitoring circuit are established for each bearing state configuration. The subcircuits can be connected in series, for example.

Different bearing state configurations arise depending on the number of open bearing locations and depending on which of the bearing locations is open.

By way of example, any possible bearing state configuration of the bearing devices can be assigned a defined resistance value of the monitoring circuit, wherein the resistance values of the subcircuits are dimensioned in such a way, and/or the subcircuits are electrically connected in such a way, that the defined resistance value of the monitoring circuit is established for the corresponding bearing state combination.

In this case, the resistance values of the monitoring circuit can be mutually different for different bearing state configurations. Consequently, depending on the previously known assignment, it is then possible to determine how many and which bearing devices are open.

In this case, a bearing state configuration can denote a combination of states of the bearing devices. Different bearing state configurations can be formed in particular by all possible combinations of states of the bearing devices.

Since the parts to be mounted on one another can be mounted on one another via a plurality of bearing devices, that is to say in particular more than one bearing device, the monitoring circuit comprises a plurality of subcircuits.

It is possible for the evaluation device to generate a fault signal if an open bearing state of at least one bearing device is detected. In this case, the fault signal can encode the number of open bearing devices. Moreover, the fault signal can encode which bearing device(s) is/are open.

The fault signal can be used for example for collision monitoring. By way of example, a fault signal can be generated if the coordinate-measuring machine is moved relative to the measurement object in such a way that the probe or a part thereof is removed, e.g. torn away, from the coordinate-measuring machine in an undesired manner.

The information about the number and/or the identity of the open bearing locations can be encoded for example in the form of a signal. Said signal can then be evaluated for generating user information, for example visual, optical, acoustic or haptic user information. It goes without saying that the user information can then be generated as well. Alternatively or cumulatively, a measure for fault treatment can be begun.

The proposed apparatus advantageously gives rise to the effect that a reliable determination both of the number of open bearing devices and of the identification thereof is made possible.

In a further embodiment, a subcircuit consists of a parallel circuit comprising at least one parallel resistor and the measuring-machine-side part of a bearing device, wherein the parallel circuits are connected in series. In this case, the parallel resistor denotes a resistor that is connected in parallel with the measuring-machine-side part of the bearing device.

In other words, this means that the monitoring circuit comprises per bearing device at least one parallel circuit comprising a resistor current path comprising at least the parallel resistor and a bearing device current path, wherein the bearing device current path forms a closed electrical connection in the closed state of the bearing device and an open electrical connection in the open state of the bearing device. In this case, the connection can be formed between terminal points of the parallel circuit. In a closed state of a bearing device, the measuring-machine-side part and the probe-side part thus form a conductive connection (closed current path), wherein the at least one parallel resistor is connected in parallel with said conductive connection. The at least one parallel resistor can have a predetermined resistance value.

Since the parts to be mounted on one another are mounted on one another via a plurality of bearing devices, that is to say in particular more than one bearing device, the monitoring circuit comprises a plurality of parallel circuits comprising a parallel resistor and a measuring-machine-side part of the respective bearing device. In this case, resistance values of the parallel circuits can be chosen in such a way that mutually different resistance values are established for each bearing state configuration.

The parallel circuits are connected in series. In particular, in the case of a series connection of the parallel circuits, the resistance values of the parallel resistors are chosen in such a way that the bearing state is determinable for each bearing device. This means that it is possible to determine for each bearing device whether the latter is open.

This advantageously makes it possible, depending on the resistance-dependent variable, firstly to determine the number of open and thus also closed bearing devices. Secondly it is possible to determine which bearing device is open or closed.

In one preferred embodiment, all the parallel resistors have mutually different resistance values. This advantageously enables a reliable determination of the number of the open bearing devices and the identification thereof.

In a further embodiment, the monitoring circuit comprises at least one protective resistor, wherein the protective resistor is arranged between the evaluation device and the subcircuits. The risk of damage to the evaluation device is advantageously reduced as a result.

In particular, it is possible to reduce a current flow to the evaluation device that arises e.g. on account of an undesired voltage spike in the subcircuits.

In a further embodiment, the monitoring circuit comprises at least one short-circuit resistor, wherein the short-circuit resistor is arranged between a subcircuit section of the monitoring circuit and a terminal point of the monitoring circuit. In this case, the subcircuit section comprises the different subcircuits of the monitoring circuit, that is to say in particular the series connection of the parallel circuits explained above. The terminal point can be in particular a terminal point connected to a reference potential.

In particular, the short-circuit resistor can be electrically arranged or connected in series with the series connection of the parallel circuits. Furthermore, the short-circuit resistor can be part of an electrical connection between terminal points of the monitoring circuit, wherein the series connection of the parallel circuits is also part of said electrical connection.

As explained in even greater detail below, it is possible for an insulation fault to occur which produces an electrical short circuit between at least one bearing device and the reference potential. The arrangement of the short-circuit resistor thus advantageously additionally makes it possible to detect an insulation fault of at least one bearing device depending on the resistance-dependent variable.

In a further embodiment, a resistance value of the short-circuit resistor is different than the resistance values of the parallel resistors. This advantageously results in a reliable detection of the insulation fault explained.

In a further embodiment, the apparatus comprises at least one device for generating a monitoring current. Furthermore, a current flow through the monitoring circuit, that is to say in particular between the terminal points of the monitoring circuit, is generatable by the device. For this purpose, the current can be fed into the monitoring circuit for example via the above-explained input terminal of the monitoring circuit. In particular, a current having a defined current intensity can be fed into the monitoring circuit.

Furthermore, a monitoring voltage dropped across the monitoring circuit is determinable or detectable as the variable dependent on the resistance of the monitoring circuit. The voltage can be detected in particular by a voltage sensor. In particular, the resistance-dependent variable can thus be a voltage that is dropped between the terminal points of the monitoring circuit. The monitoring voltage can furthermore in particular thus be dropped between the input terminal of the monitoring circuit and the reference potential explained above if the output terminal of the monitoring circuit is connected to the reference potential.

This advantageously results in a simple and reliable determination of the resistance-dependent variable.

It is possible for the determination of the number of open bearing devices and the identification of the open bearing devices to be carried out depending on a voltage value. For this purpose, an analog voltage signal can be digitized, for example by means of an A/D-converter. The latter can be part of the proposed apparatus, in particular part of the evaluation device. For this purpose, the A/D converter and/or the evaluation device can be connected to the monitoring circuit in such a way that the monitoring voltage is present at terminals of the A/D converter or at terminals of the evaluation device.

By means of the at least one evaluation device, the determination of the number of open bearing devices and the identification can then be carried out depending on the voltage value.

It goes without saying that it is also possible to compare the monitoring voltage with predetermined voltage threshold values. This can be carried out for example by means of one comparator or a plurality of comparators. In this case, the determination of the number of open bearing devices and the identification of the open bearing devices can be carried out depending on the output signals of the comparator(s).

In a further embodiment, a measuring-machine-side bearing section comprises the measuring-machine-side parts of the bearing devices. This has already been explained above.

Furthermore, the measuring-machine-side bearing section is electrically connected to a reference potential. Furthermore, the measuring-machine-side part of each bearing device is electrically insulated from the reference potential, in particular in a fault-free state. In this case, the measuring-machine-side parts can be insulated from the measuring-machine-side bearing section.

The reference potential can be in particular the reference potential explained above, that is to say in particular a ground potential. In the fault-free state, there is thus an electrical insulation between the measuring-machine-side part of the bearing device and the measuring-machine-side bearing section. What is advantageously achieved by the electrical insulation is that the bearing-device-specific determination of the bearing state can be carried out in a reliable manner since, in the fault-free state, there is an electrical insulation between bearing device and reference potential and the risk of a fault current that would make it more difficult to perform the above-explained determination of the resistance-dependent variable is thus minimized.

In a further embodiment, a probe-side bearing section comprises the probe-side parts of the bearing devices. This has been explained above. Furthermore, the probe-side bearing section is connected to a reference potential, in particular in the mounted state, and the probe-side part of each bearing device is electrically insulated from the reference potential. In this case, the probe-side parts can be insulated from the probe-side bearing section.

This advantageously likewise results in a more reliable determination of the bearing state of each bearing device, since the risk of a fault current is also reduced in the probe or a part thereof.

In a further embodiment, the apparatus comprises at least one device for determining an acceleration of the coordinate measuring machine, in particular of a movable part of the coordinate measuring machine. Alternatively or cumulatively, the apparatus comprises at least one device for determining an acceleration of the probe or part thereof. The device for determining the acceleration can comprise in particular an acceleration sensor. This is not mandatory, however. Moreover, it is possible to determine an acceleration depending on control signals for the movement of the movable part or depending on acceleration, speed or distance signals, in particular on corresponding setpoint or actual values, of the movable part.

Furthermore, an acceleration-based bearing opening force is determinable depending on the acceleration for each bearing device. In this case, the acceleration-based bearing opening force denotes a force that acts on the corresponding bearing device, in particular on the measuring-machine-side part of the bearing device and/or on the probe-side part of the respective bearing device, on account of the acceleration.

It is possible, for example, for a probe or a part thereof to have a large mass. Probes that are secured via extension elements on the coordinate measuring machine or comprise such extension elements can also have relatively large masses.

Depending on the acceleration, forces that lead to the opening of one or a plurality of bearing device(s) can be generated on account of the mass and said acceleration, wherein said forces can also be referred to as acceleration-based bearing opening forces. This opening can also be referred to as acceleration-governed opening. By way of example, upon acceleration-governed opening, an acceleration-based bearing opening force can be dimensioned and/or oriented in such a way that the bearing device is opened.

However, the acceleration-governed opening differs from the collision-governed opening of bearing devices. In particular, the acceleration-governed opening can last only for a certain time duration, e.g. until the reduction of the acceleration below a predetermined threshold value. In this case, the bearing device can return from the open state to the closed state again, in particular since the acceleration-governed forces are once again smaller than the attractive/securing forces between the measuring-machine-side and probe-side bearing sections or parts of the bearing devices. For a bearing device, said attractive/securing forces can also be referred to as bearing-device-specific securing force. It may be desirable in such a case not to generate a fault signal which represents a collision state.

Furthermore, a fault signal is generatable depending on the bearing state and the acceleration-based bearing opening force. By way of example, a fault signal can be generated if, for a bearing device, an open bearing state and an acceleration-based bearing opening force which does not suffice for opening the bearing device are determined. This may be the case if the acceleration-based bearing opening force is dimensioned and/or oriented in such a way that it does not suffice for opening the bearing device. In particular, the acceleration-governed bearing opening force can be smaller than the bearing-specific securing force. In this case it can be assumed that the securing force provided would have to suffice to produce the closed bearing state upon movement of the probe.

Furthermore, it is possible not to generate a fault signal if, for a bearing device, an open bearing state is detected but an acceleration-based bearing opening force that is dimensioned and/or oriented in such a way that it suffices for opening the bearing device.

The acceleration-based bearing opening force can suffice for opening the bearing device in particular if it is greater than a bearing-device-specific securing force. An acceleration-based bearing opening force that suffices for opening the bearing device can be known beforehand, for example can be determined by calibration or simulation.

Moreover, a fault signal can be generated if, for a bearing device, an open bearing state is detected and an acceleration-based bearing opening force is detected which is dimensioned and/or oriented in such a way that it suffices for opening the bearing device and the open state is manifested for longer than a predetermined, defined time duration and/or the open state is manifested even if the acceleration-based bearing opening force changes in such a way that it does not suffice for opening the bearing device.

This advantageously results in improved operation of the coordinate measuring machine, since acceleration-governed opening of a bearing device does not lead to the generation of a fault signal and, if appropriate, to immediate initiation of a collision treatment.

An acceleration-based bearing opening force is determinable in particular depending on a position of the bearing devices. In this case, the position can be previously known or determinable. In particular, the position can be determined in a fixed coordinate system appertaining to the coordinate measuring machine.

By way of example, the acceleration can be determined depending on a travel command, that is to say a setpoint value of a movement control, for a movable part of the coordinate system. It goes without saying, however, that it is also conceivable to detect an acceleration, for example by means of at least one acceleration sensor.

It is furthermore conceivable for a position of the bearing devices in a fixed coordinate system appertaining to the coordinate measuring machine to be variable, particularly if the bearing devices are arranged on a so-called rotary-pivoting joint. In this case, e.g. a sensor can be mounted on the rotary-pivoting joint. In this case, therefore, the rotary-pivoting joint can form a sensor carrier. In this case, too, however, the position of the bearing devices can be determined depending on rotation angles of the rotary-pivoting joint.

Since it is thus possible to determine which bearing device is open and likewise which acceleration-based bearing opening forces act on an open bearing device, an improved fault treatment can advantageously be carried out.

Consequently, a description is also given of the apparatus for controlling operation of a coordinate measuring machine, wherein the apparatus for operation comprises the apparatus for monitoring a bearing state. An open bearing state can be detected by means of the apparatus for monitoring the bearing state. By way of example, a fault signal can be generated in this case. Moreover, a fault signal can be generated depending on the bearing state and the acceleration-based bearing opening force. This has already been explained above.

It is possible for the apparatus for controlling operation to carry out at least one measure for fault treatment, in particular for collision treatment, if a fault signal was generated. The measure for fault treatment can be for example interruption of the operation of the coordinate measuring machine, in particular interruption of a movement of the movable part of the coordinate measuring machine. It goes without saying that it is possible for the movable part to be moved into a predetermined fault position prior to the interruption. If, as explained above, depending on an acceleration-based bearing opening force, despite an open bearing device, a fault signal is not generated, then it is possible not to initiate a measure for fault treatment, that is to say it is possible in particular for operation to be continued.

A method for monitoring a bearing state of a probe or probe part of a coordinate measuring machine is furthermore proposed. In this case, the method is implementable by means of an apparatus in accordance with one of the embodiments explained in this disclosure.

As explained above, the probe-side bearing section can be mounted on the measuring-machine-side bearing section via a plurality of bearing devices, in particular more than one bearing device. Furthermore, a variable dependent on a resistance of a monitoring circuit is determined, wherein the monitoring circuit comprises at least one subcircuit per bearing device.

According to the invention, the monitoring circuit comprises at least one subcircuit per bearing device, wherein a resistance value of the subcircuit in a closed state of the bearing device is different than a resistance value of the subcircuit in the open state of the bearing device.

Furthermore, an open or closed bearing state of each bearing device is determined depending on the variable dependent on the resistance of the monitoring circuit.

This advantageously results in a simple and reliable determination of open bearing states and the determination of which bearing devices are open. In particular, the subcircuits can be designed as parallel circuits, wherein the parallel circuits are connected in series. The monitoring circuit can thus comprise this series connection.

In a further embodiment, different bearing state configurations are assigned in each case mutually different values of the variable dependent on the resistance of a monitoring circuit. Furthermore, an open or closed bearing state of each bearing device is determined depending on the variable dependent on the resistance of the monitoring circuit and this assignment. This and corresponding advantages have been explained above.

In a further embodiment, an insulation fault of a bearing device is detected depending on the variable dependent on the resistance of the monitoring circuit. For this purpose, the monitoring circuit can comprise the short-circuit resistor explained above. If such an insulation fault is detected, then a fault signal can be generated. In this case, the fault signal can represent in particular the insulation fault or the information of an insulation fault present. Consequently, the fault signal in the case of an insulation fault can be different than the fault signal in the case of an open bearing device.

This and corresponding advantages have already been explained above.

In a further embodiment, a current flow through the monitoring circuit is generated, wherein a monitoring voltage dropped across the monitoring circuit is determined as the variable dependent on the resistance of the monitoring circuit. This and corresponding advantages have already been explained above.

In a further embodiment, an acceleration of the coordinate measuring machine and/or of the probe or probe part is determined. Furthermore, an acceleration-based bearing opening force is determined depending on the acceleration for each bearing device, wherein a fault signal is generated depending on the bearing state and the acceleration-based bearing opening force. This and corresponding advantages have already been explained above.

### BRIEF DESCRIPTION OF THE DRAWINGS

The invention will be explained in greater detail on the basis of exemplary embodiments. In the figures:

FIG. 1 shows a monitoring circuit in accordance with the prior art,

FIG. 2 shows a further monitoring circuit in accordance with the prior art,

FIG. 3 shows a schematic illustration of an apparatus according to the invention,

FIG. 4 shows a schematic flow diagram of a method according to the invention, and

FIG. 5 shows a schematic illustration of a coordinate measuring machine with a plurality of possible bearing devices.

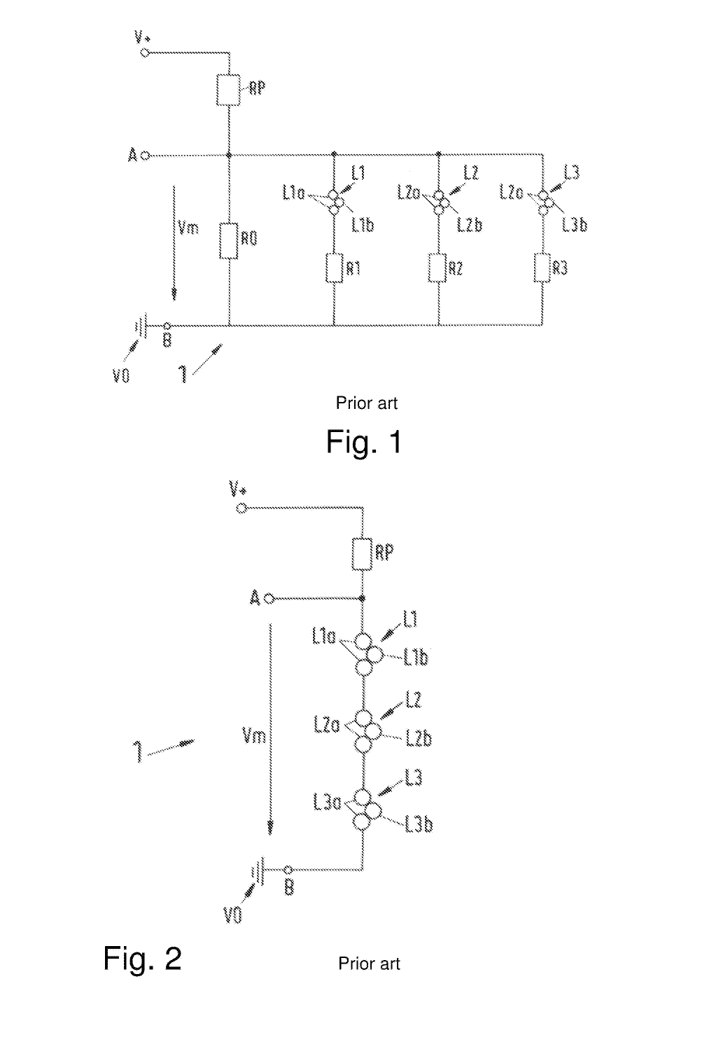

### DETAILED DESCRIPTION OF THE PREFERRED EMBODIMENTS

Identical reference signs hereinafter designate elements having identical or similar technical features.

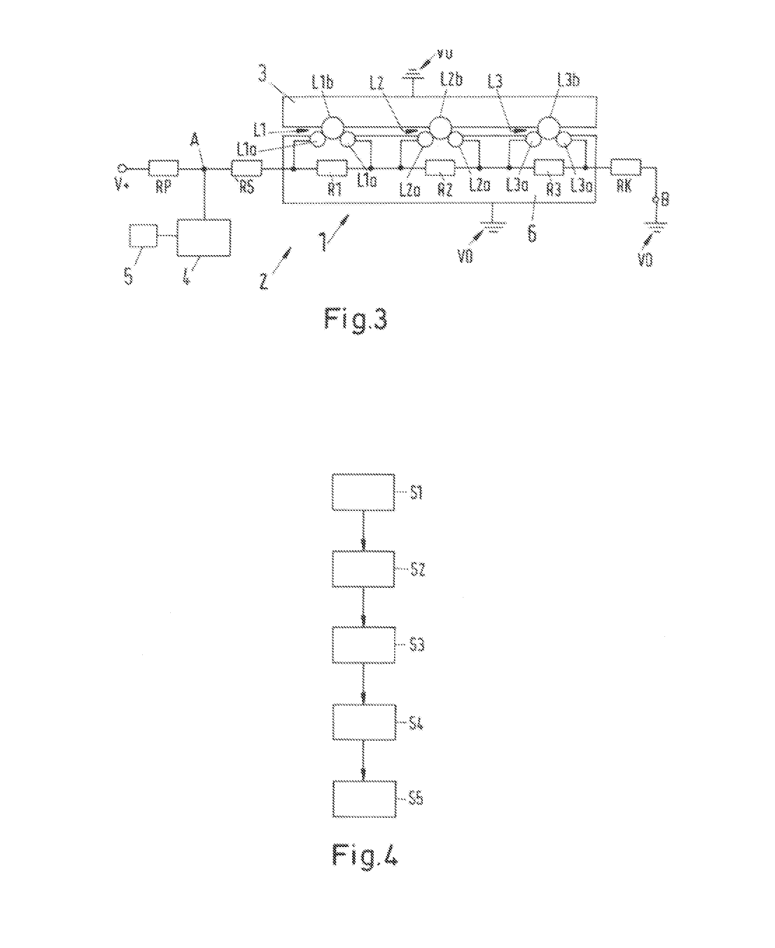

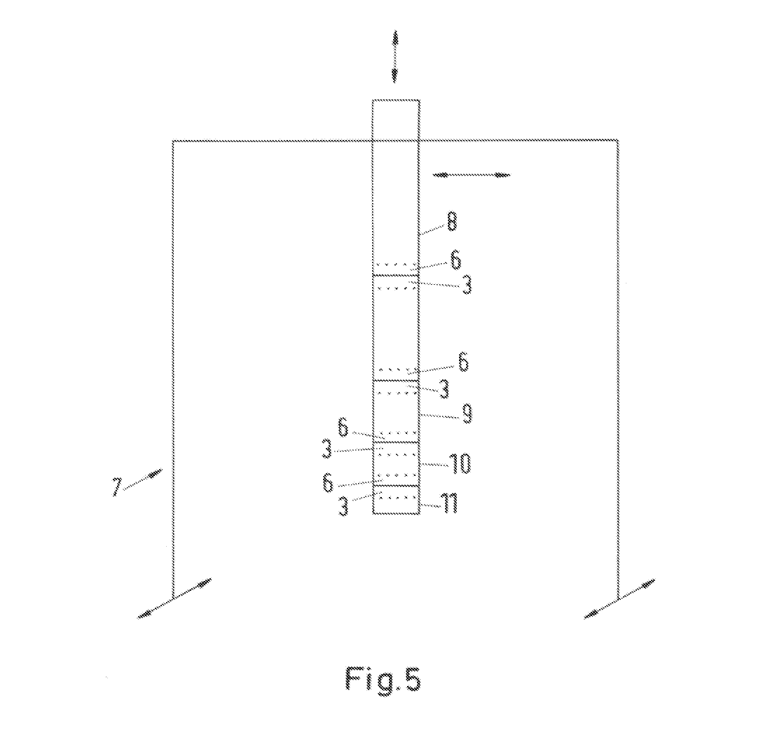

FIG. 3 shows a schematic block diagram of an apparatus 2 according to the invention for monitoring a bearing state of a probe of a coordinate measuring machine 7 (see FIG. 5). In this case, the probe comprises a probe-side bearing section 3 designed as a probe plate. The latter has probe-side parts L1b, L2b, L3b of bearing devices L1, L2, L3, wherein the probe-side parts L1b, L2b, L3b of the bearing devices L1, L2, L3 are electrically insulated from the probe-side bearing section 3. The illustration furthermore shows that the probe-side bearing section 3 is connected to a reference potential V0, in particular a ground potential.

A measuring-machine-side bearing section 6 is furthermore illustrated. By way of example, a measuring arm 8 of the coordinate measuring machine 7 can comprise or form the measuring-machine-side bearing section 6. The measuring-machine-side bearing section 6 has the measuring-machine-side parts L1a, L2a, L3a.

The apparatus 2 furthermore comprises an evaluation device 4, which can comprise an A/D converter, for example.

The apparatus 2 furthermore comprises a monitoring circuit 1. The monitoring circuit 1 comprises a series connection of a protective resistor RS, three parallel circuits and a short-circuit resistor RK. A first parallel circuit is a parallel circuit formed by a parallel resistor R1 and a measuring-machine-side part L1a of a first bearing device L1. A second parallel circuit is a parallel circuit formed by a second parallel resistor R2 and a measuring-machine-side part L2a of a second bearing device L2. A third parallel circuit is a parallel circuit formed by a third parallel resistor R3 and a measuring-machine-side part L3a of a third bearing device L3.

In an open state of the respective bearing device L1, L2, L3, the current path with the respective measuring-machine-side part L1a, L1b, L1c is open since the current path is not closed via a probe-side part of the bearing device L1b, L2b, L3b. In a closed state of the respective bearing device L1, L2, L3, the current path with the respective measuring-machine-side part L1a, L1b, L1c is closed, wherein the electrical connection is produced via the measuring-machine-side and probe-side parts L1a, . . . , L3b.

In an open state of the bearing devices L1, L2, L3, the resistance value of the respective parallel circuit is equal to the resistance value of the respective parallel resistor R1, R2, R3. In a closed state of the bearing devices L1, L2, L3, the resistance value of the respective parallel circuit is equal to the resistance value of a parallel circuit comprising the respective parallel resistor R1, R2, R3 and the resistance of a closed electrical connection provided via the measuring-machine-side and probe-side parts L1a, . . . , L3b.

Furthermore, the protective resistor RS is arranged between an input terminal A of the monitoring circuit 1 and a series connection of the parallel circuits. The short-circuit resistor RK is arranged between an output terminal B of the monitoring circuit 1 and the series connection of the parallel circuits. The output terminal B of the monitoring circuit 1 is connected to the reference potential V0.

A supply voltage terminal V+ is furthermore illustrated, to which a supply voltage is applied. A pull-up resistor RP is arranged between the input terminal A of the monitoring circuit 1 and the supply voltage terminal V+. If a supply voltage is applied, then a monitoring current flows through the monitoring circuit 1. Furthermore, in this case, a monitoring voltage Vm (not illustrated) is dropped between the input terminal A and the output terminal B.

FIG. 3 illustrates that all three bearing devices L1, L2, L3 are in the closed state. In this case, the resulting resistances of the individual parallel circuits arise depending on the parallel resistors R1, R2, R3 and the resistances provided by the electrical connection of the individual bearing devices L1, L2, L3, in particular by the electrical connection of the measuring-machine-side part Da to the probe-side part L1b.

If a bearing device L1, L2, L3 is open, then the resistance of the parallel circuit arises as the resistance of the corresponding parallel resistor R1, R2, R3.

FIG. 3 illustrates that the measuring-machine-side part L1a, L2a, L3a of each bearing device L1, L2, L3 comprises in each case two balls. The probe-side part L1b, L2b, L3b of the bearing devices L1, L2, L3 comprises in each case one ball. The balls here can be formed from electrically conductive material. The balls here are arranged and/or designed in such a way that the probe is mountable in a reproducible position and/or orientation of the coordinate measuring machine 7, in particular the movable part of the coordinate measuring machine 7.

The resistance values of the protective resistor RS of the parallel resistors R1, R2, R3 and of the short-circuit resistor RK are dimensioned here in such a way that, depending on the voltage value of the monitoring voltage which is detected by the evaluation device 4, it is possible to determine unambiguously how many bearing devices L1, L2, L3 are open and which bearing devices L1, L2, L3 are open. In particular, it is thus possible to determine whether the first bearing device L1 and/or whether the second bearing device L2 and/or whether the third bearing device L3 are/is open.

Furthermore, depending on the voltage value, it is possible to determine unambiguously whether there is an insulation fault of at least one measuring-machine-side part L1a, L2a, L3a of the bearing devices L1, L2, L3 or an insulation fault of at least one probe-side part L1b, L2b, L3b of the bearing device L1, L2, L3.

A fault signal can be generated by means of the evaluation device 4 if an open bearing state of a bearing device L1, L2, L3 is detected. The fault signal can be generated depending on the voltage value of the monitoring voltage Vm.

Consequently, the resistance values of the parallel resistors R1, R2, R3 and of the protective resistor RS are chosen in such a way that mutually different voltage values arise for each bearing state combination.

Furthermore, by means of the evaluation device 4 it is possible to detect whether an insulation fault is present in a bearing device L1, L2, L3. In this case, the short-circuit resistor RK is bridged since there is an electrically conductive connection of a probe-side part L1b, L2b, L3b to the reference potential or an electrically conductive connection of a measuring-machine-side part L1a, L2a, L3a to the reference potential V0.

In this regard, by way of example, a previously known assignment, for example in the form of a table, can exist in which voltage values of the voltage between the input terminal A and the output terminal B of the monitoring circuit 1 are assigned to a bearing state of each bearing device L1, L2, L3 and to a short-circuit state.

In this case, it is conceivable for the pull-up resistor RP and the protective resistor RS to be arranged in a housing of the evaluation device 4.

By way of example, the resistance value of the short-circuit resistor RK can be 1 kΩ. A resistance value RP of the pull-up resistor RP can be 68.1 kΩ. A resistance value of the protective resistor can be 1 kΩ. A resistance value of the first parallel resistor R1 can be for example 40.2 kΩ. A resistance value of the second parallel resistor R2 can be for example 20 kΩ. A resistance value of the third parallel resistor R3 can be for example 10 kΩ.

The supply voltage can be for example 4.75 V. The supply voltage can for example likewise be provided by the evaluation device 4. The reference voltage V0, too, can be provided by the evaluation device 4.

By way of example, if no insulation fault occurs and if all bearing devices L1, L2, L3 are in the closed state, then the monitoring voltage Vm can be 0.39 V. If no insulation fault occurs and if e.g. the third bearing device L3 is open and the first and second bearing devices L2, L3 are closed, then the monitoring voltage Vm can be for example 0.908 V. If e.g. the second bearing device L2 is open and the first and also the third bearing device L1, L3 are closed, then the monitoring voltage Vm can be for example 1.316 V. If only the first bearing device L1 is closed and the two remaining bearing devices L2, L3 are open, then the monitoring voltage Vm can be for example 1.846 V. If the first bearing device L1 is open and the second and third bearing devices L2, L3 are closed, then the monitoring voltage Vm can be 1.922 V. If the first and third bearing devices L1, L3 are open and the second bearing device L2 is closed, then the monitoring voltage Vm can be 2.160 V. If the first and second bearing devices L1, L2 are open and the third bearing device L3 is closed, then the monitoring voltage Vm can be 2.343 V. If all bearing devices L1, L2, L3 are open, then the monitoring voltage Vm can be 2.510 V.

The illustration furthermore shows that the apparatus 2 comprises an acceleration sensor 5. The acceleration sensor 5 can detect an acceleration of the movable part of the coordinate measuring machine 7 and/or of the probe or probe part and can generate a corresponding output signal. The acceleration sensor 5 is connected to the evaluation device 4 in terms of data and/or signal technology.

Depending on the acceleration, the evaluation device 4 can determine for each bearing device L1, L2, L3 what acceleration-dictated bearing opening force acts on the respective bearing devices L1, L2, L3.

The illustration does not show a first alternating magnet for securing the probe-side bearing section 3 on the measuring-machine-side bearing section 6. Said magnet comprises a permanent magnet and an electromagnet. In this case, the electromagnet is arranged and designed in such a way that it can neutralize the magnetic force of the permanent magnet in a neutralization operating mode. In this case, the permanent magnet and the electromagnet can be arranged for example in a measuring-machine-side bearing section 6. In this case, the probe-side bearing section 3 can comprise an anchor plate (not illustrated) that can be attracted by a magnetic force of the magnets in the measuring-machine-side bearing section 6. In particular, the anchor plate and thus the probe-side bearing section 3 can be attracted and secured on the measuring-machine-side bearing section 6 when the electromagnet is operated in a securing operating mode other than in the neutralization operating mode. In the securing operating mode, the electromagnet can generate in particular an attractive force that acts on the probe-side bearing section 3, which force can also be referred to as securing force.

However, by means of the evaluation device 4 it is possible for a fault signal not to be generated if a bearing-device-specific acceleration-governed bearing opening force is detected which suffices for opening the corresponding bearing device L1, L2, L3 even under the action of the securing force. If this is the case, then it can be assumed that the process of opening the bearing device L1, L2, L3 is acceleration-governed opening.

However, in such a case, a fault signal can be generated if the open bearing state is detected for longer than a predetermined time duration and/or the bearing-specific acceleration-governed bearing opening force changes in such a way that it no longer suffices for opening the corresponding bearing device L1, L2, L3 even with a given securing force.

FIG. 4 illustrates a schematic flow diagram of a method according to the invention. A first step involves applying a reference voltage to a reference voltage terminal V+ of an apparatus 2 (see FIG. 3). A second step S2 involves detecting a monitoring voltage Vm between an input terminal A and an output terminal B (see FIG. 3).

A third step S3 involves comparing the detected monitoring voltage Vm with voltage entries in an assignment, wherein voltage values of the monitoring voltage Vm are assigned to different bearing state configurations and short-circuit states by the assignment. Depending on the value of the monitoring voltage Vm and the assignment, it is then possible to determine whether and if so which bearing devices L1, L2, L3 are open and closed. Furthermore, it is possible to determine whether an insulation fault is present.

An acceleration of the coordinate measuring machine 7 or of the probe or of a probe part can be determined, in particular detected, in a fourth step S4. Furthermore, it is possible to determine whether an open bearing state of a bearing device L1, L2, L3 is an acceleration-governed open bearing state. In this case, in a fifth step S5, it is possible for a fault signal not to be generated. However, if an open bearing state is not an acceleration-governed open bearing state, then a fault signal can be generated in the fifth step S5.

FIG. 5 shows a schematic illustration of a coordinate measuring machine 7 with a plurality of possible bearing devices or interface devices. The illustration shows a movable part of the coordinate measuring machine 7, said movable part being designed as a measuring arm 8. A sensor carrier 9 is mounted on a free end of the measuring arm 8. A sensor 10 is mounted on one end of the sensor carrier 9.

The sensor 10 can be designed as a tactile sensor 10 and comprise a stylus 11, which is in turn mounted on the part of the sensor 10 which is mounted on the sensor carrier 9.

The illustration shows in each case the measuring-machine-side bearing sections 6 and the probe-side bearing sections 3, wherein these bearing sections 3, 6 respectively form a mechanical interface. In this case, the measuring arm 8 has a measuring-machine-side bearing section 6, wherein the sensor carrier 9 has the probe-side bearing section 3. Furthermore, the sensor carrier 9 also has a measuring-machine-side bearing section 6, wherein the sensor 10 has a probe-side bearing section 3. Furthermore, the sensor 10 has a measuring-machine-side bearing section 6, on which the stylus 11 can be mounted by a probe-side bearing section 3 of the stylus 11.

The illustration furthermore also shows a mechanical interface in the measuring arm 8, which mechanical interface can serve for protection against buckling. In this case, a part of the measuring arm 8 that is secured on a gantry of the coordinate measuring machine 7 has the measuring-machine-side bearing section 3 and the remaining part of the measuring arm 8 has the probe-side bearing section 6.

It goes without saying that embodiments that do not comprise all the interfaces illustrated in FIG. 5 are also conceivable. Embodiments in which the sensor 10 is mounted on the measuring arm 8 via an interface are also conceivable. Embodiments in which the sensor 10 does not have an interface for mounting a stylus 11 are also conceivable. Consequently, a probe can denote various arrangements, e.g. an arrangement with a remaining part of the measuring arm 8 and/or with a sensor carrier 9 and/or with a sensor 10 and/or with a stylus 11.

1. An apparatus for monitoring a bearing state of a probe or probe part of a coordinate measuring machine, wherein a probe-side bearing section is mountable on a measuring-machine-side bearing section via a plurality of bearing devices, wherein the apparatus comprises:
at least one evaluation device and at least one monitoring circuit, wherein a variable dependent on a resistance of the monitoring circuit is determinable,
wherein the monitoring circuit comprises at least one subcircuit per bearing device,
wherein a resistance value of the subcircuit in a closed state of the bearing device is different than a resistance value of the subcircuit in the open state of the bearing device, and
wherein the monitoring circuit is designed in such a way that an open or closed bearing state of each bearing device is determinable depending on the variable dependent on the resistance of the monitoring circuit.

2. The apparatus as claimed in claim 1, wherein a subcircuit consists of a parallel circuit comprising at least one parallel resistor and the measuring-machine-side part of a bearing device, wherein the parallel circuits are connected in series.

3. The apparatus as claimed in claim 2, wherein all the parallel resistors have mutually different resistance values.

4. The apparatus as claimed in claim 2, wherein the monitoring circuit comprises at least one protective resistor, wherein the protective resistor is arranged between the evaluation device and the parallel circuits.

5. The apparatus as claimed in claim 2, wherein the monitoring circuit comprises at least one short-circuit resistor, wherein the short-circuit resistor is arranged between the parallel circuits and a reference potential.

6. The apparatus as claimed in claim 5, wherein a resistance value of the short-circuit resistor is different than the resistance values of the parallel resistors.

7. The apparatus as claimed in claim 1, wherein the apparatus comprises at least one device for generating a monitoring current, wherein a current flow through the monitoring circuit is generatable by the device, wherein a monitoring voltage falling across the monitoring circuit is determinable as the variable dependent on the resistance of the monitoring circuit.

8. The apparatus as claimed in claim 1, wherein the measuring-machine-side bearing section comprises or has the measuring-machine-side parts of the bearing devices, wherein the measuring-machine-side bearing section is electrically connected to a reference potential, wherein the measuring-machine-side parts of the bearing devices are electrically insulated from the reference potential.

9. The apparatus as claimed in claim 1, wherein the probe-side bearing section comprises or has the probe-side part of the at least one bearing device, wherein the probe-side bearing section is electrically connected to the reference potential, wherein probe-side parts of the bearing devices are electrically insulated from the reference potential.

10. The apparatus as claimed in claim 1, wherein the apparatus comprises at least one device for determining an acceleration of the coordinate measuring machine and/or of the probe or probe part, wherein an acceleration-based bearing opening force is determinable depending on the acceleration for each bearing device, wherein a fault signal is generatable depending on the bearing state and the acceleration-based bearing opening force.

11. A method for monitoring a bearing state of a probe or probe part of a coordinate measuring machine, including the steps of:
mounting a probe-side bearing section on a measuring-machine-side bearing section via a plurality of bearing devices,
determining a variable dependent on a resistance of a monitoring circuit, wherein the monitoring circuit comprises at least one subcircuit per bearing device,
establishing a resistance value of the subcircuit in a closed state of the bearing device that is different than a resistance value of the subcircuit in the open state of the bearing device, wherein the monitoring circuit is designed in such a way that an open or closed bearing state of each bearing device is determinable depending on the variable dependent on the resistance of the monitoring circuit, and
determining an open or closed bearing state of each bearing device depending on the variable dependent on the resistance of the monitoring circuit.

12. The method as claimed in claim 11, wherein different bearing state combinations are assigned in each case mutually different values of the variable dependent on the resistance of the monitoring circuit, and further wherein an open or closed bearing state of each bearing device is determined depending on the variable dependent on the resistance of the monitoring circuit and the assignment.

13. The method as claimed in claim 11, further including the step of detecting an insulation fault of at least one bearing device depending on the variable dependent on the resistance of the monitoring circuit.

14. The method as claimed in claim 11, further including the step of generating a current flow through the monitoring circuit and determining a monitoring voltage drop across the monitoring circuit as the variable dependent on the resistance of the monitoring circuit.

15. The method as claimed in claim 11, further including the steps of:
determining an acceleration of the coordinate measuring machine and/or of the probe or probe part and an acceleration-based bearing opening force depending on the acceleration for each bearing device, and
generating a fault signal depending on the bearing state and the acceleration-based bearing opening force.
